(19) United States
(12) Patent Application Publication
(10) Pub. No.: US 2019/0011383 A1
(43) Pub. Date: Jan. 10, 2019

(54) APPARATUS AND METHOD FOR QUALITY DETECTION OF A PROCESSED PRODUCT

(71) Applicant: ASPECT AI LTD., Shoham (IL)

(72) Inventors: Tal COHEN, Herzliya (IL); Uri RAPOPORT, Moshav Ben Shemen (IL)

(73) Assignee: ASPECT AI LTD., Shoham (IL)

(21) Appl. No.: 15/576,751

(22) PCT Filed: May 26, 2016
(86) PCT No.: PCT/IL2016/050549

§ 371 Date: Nov. 24, 2017

Related U.S. Application Data
(60) Provisional application No. 62/166,175, filed on May 26, 2015.

(51) Int. Cl. G01N 24/08; G05B 15/02

(52) U.S. Cl. CPC G01N 24/085; G05B 15/02; G01N 24/087; G01N 24/081

(57) ABSTRACT

Some embodiments are related to a portable or stationary system for determining the quality of processed food product. The system can be hand handled by a user, located on a production line or placed a laboratory. The system can include a Nuclear Magnetic Resonance (NMR) spectrometer and a controller. The controller can be configured to: receive an NMR spectrum of the processed food product from the NMR spectrometer, identify a first peak related to a first component of the processed food product from the received NMR spectrum and determine the quality of the processed food product based on the identification. The controller may further configured to control parameters of the production line based on the determined quality.

### BACKGROUND OF THE INVENTION

The quality of processed products, for example, in the food industry may rely on a variety of factors, such as, an origin of a raw material from which the processed product is made, an accurateness in which the processed product is being processed (e.g., the relative amount of the ingredients or the components), storing conditions of the product and/or the like. For example, quality of wines can depend heavily on the origin, type and/or quality of grapes used to make the wine, precision of the fermentation process, an aging process (e.g., a specific type of oak barrel used for the ageing) or the like. In another example, olive oil quality can depend on a type and/or quality of olives used to make the olive oil, a type of cold and/or warm press (or centrifugation) used for extracting the oil from the olives and/or the storing conditions in which the olive oil, e.g., once bottled, is kept.

Quality of processed foods can also be affected by adulterating a processed material with material of the same type but lesser quality, adding artificial materials, such as sugar or water, to an allegedly natural product, and/or adding a related, but cheaper material. For example, adding mandarin juice to orange juice, when the latter is the more expensive.

Cooking oils, when heated, can hydrogenate, which can cause an increase in a number of double bonds between carbons that form the oil's carbon chain. One of the effects of hydrogenation can be an increase in the oil's solidification temperature, such that the oil becomes solid or semi-solid at room temperature. Some of the hydrogenation products and/or some of the degradation products can be carcinogenic. Typically, the longer a batch of oil remains in use, the larger the fraction of degradation products in the oil, and the greater the probability that the oil will contain a significant fraction of carcinogenic material.

Therefore, detection of degradation of quality of food products can be an important tool for ensuring manufacturing and/or distribution of a high quality, safe and/or healthy products. Current commercial methods for quality detection of food products can be slow and time-consuming

### SUMMARY OF THE INVENTION

An advantage of the invention can include reduction in waste (e.g., cost) during food processing production due to, for example, an ability to detect food quality in real-time. Another advantage of the invention can include accurate estimation of the food quality due to, for example, fidelity for which a Magnetic Resonance Device (“MRD”) can image.

Furthermore, the NMD can conduct a Nuclear Magnetic Resonance (NMR) spectrometry measurements that are non-destructive to the food product, due to, for example, the low magnetic felid used. Accordingly, another advantage of the invention can be the ability to detect quality of a product during the production or storage stages without the need to damage the detected sample (e.g., a bottle of oil). If the quality detected was satisfying, the detected sample can be sent back to the production line or the storage.

Embodiments of the invention may be related to a portable system for determining the quality of processed food product. The system may include a Nuclear Magnetic Resonance (NMR) spectrometer and a controller. The controller may be configured to receive an NMR spectrum of the processed food product from the NMR spectrometer, identify a first peak related to a first component of the processed food product from the received NMR spectrum, and determine the quality of the processed food product based on the identification. In some embodiments, the portable system may be safe to be handled by a human user.

In some embodiments, the first component is an undesired component. In some embodiments, the processed food product is cooking oil and the undesired component is at least one of: free fatty acids, hydroperoxides, polymerized triglycerides, aflatoxin and Polycyclic Aromatic Hydrocarbons (PAHs).

In some embodiments, the controller is further configured to calculate a normalized area beneath the first peak and determine the quality of the processed food product further based on the calculated normalized area.

In some embodiments, the controller may further is configured to identify a second peak related to a second component of the processed food product from the received NMR spectrum, calculate a ratio between an area beneath the first peak and an area beneath the second peak and determine the quality of the processed food product further based on the calculated ratio. For example, the processed food product may be an alcoholic beverage and the first component may be water and the second component may be alcohol. In another example, the processed food product may be a fruit juice and the first component may be a first type of sugar and the second component may be a second type of sugar. In yet another example, the processed food product may be cooking oil and the first component may be a first type of fat acid and the second component may be a second type of fat acid.

Some embodiments of the invention may be directed to a system for controlling a production line of a processed food product. The system may include a Nuclear Magnetic Resonance (NMR) spectrometer, located on the production line and a controller. In some embodiments, the controller is configured to receive an NMR spectrum of the processed food product from the NMR spectrometer during the production of the processed food product and identify a first peak related to a first component of the processed food product from the received NMR spectrum. In some embodiments, the controller is further configured to determine the quality of the processed food product based on the identification and control the production line based on the determined quality.

In some embodiments, controlling the production line comprises stopping the production line when the quality of the processed food product passes an allowed range. In some embodiments, controlling the production line comprises changing a production parameter of the production line when the quality of the processed food product passes an allowed range. In some embodiments, the first component is an undesired component.

In some embodiments, the controller is further configured to calculate a normalized area beneath the first peak and determine the quality of the processed food product further based on the calculated normalized area.

In some embodiments, the controller is further configured to identify a second peak related to a second component of the processed food product from the received NMR spectrum, calculate a ratio between an area beneath the first peak and an area beneath the second peak and determine the quality of the product further based on the calculated ratio.

Embodiments of the invention may include a method of detecting a quality of a processed food product. The method may include: receiving via a Nuclear Magnetic Resonance (NMR) spectrometer an NMR spectrum of the processed food product, identifying a first peak related to a first component of the processed food product from the received NMR spectrum and determining the quality of the processed food product based on the identification. In some embodiments, the first component is an undesired component. In some embodiments, the processed food product is cooking oil and the undesired component is at least one of: free fatty acids, hydroperoxides, polymerized triglycerides, aflatoxin and Polycyclic Aromatic Hydrocarbons (PAHs).

The method may further include calculating a normalized area beneath the first peak and determining the quality of the processed food product further based on the calculated normalized area.

The method may further include: identifying a second peak related to a second component of the processed food product from the received NMR spectrum, calculating a ratio between an area beneath the first peak and an area beneath the second peak and determining the quality of the product further based on the calculated ratio. For example, the processed food product may be an alcoholic beverage and the first component may be water and the second component may be alcohol. In another example, the processed food product may be a fruit juice and the first component may be a first type of sugar and the second component may be a second type of sugar. In yet another example, the processed food product may be cooking oil and the first component may be a first type of fat acid and the second component may be a second type of fat acid.

Some additional embodiments of the invention may be related to a method of controlling a production line of a processed food product. The method may include receiving via a Nuclear Magnetic Resonance (NMR) spectrometer, located one the production line, an NMR spectrum of the processed food product, during the production of the processed food product and identifying a first peak related to a first component of the processed food product from the received NMR spectrum. The method may further include, determining the quality of the product based on the identification and controlling the production line based on the determined quality. In some embodiments, controlling the production line comprises stopping the production line when the quality of the processed food product passes an allowed range. In some embodiments, controlling the production line comprises changing a production parameter of the production line when the quality of the processed food product passes an allowed range.

Some additional embodiments of the invention may be related to a system for determining the quality of cooking oil. The system may include a Nuclear Magnetic Resonance (NMR) spectrometer and a controller. The controller may be configured to: receive an NMR spectrum of the cooking oil from the NMR spectrometer, identify a first peak related to a component of the cooking oil from the received NMR spectrum and determine the quality of the cooking oil based on the identification.

### BRIEF DESCRIPTION OF THE FIGURES

The subject matter regarded as the invention is particularly pointed out and distinctly claimed in the concluding portion of the specification. The invention, however, both as to organization and method of operation, together with objects, features, and advantages thereof, may be understood by reference to the following detailed description when read with the accompanying drawings in which:

FIG. 1A is a diagrammatic presentation of a system for determining a quality of a processed food product, according to some embodiments of the invention;

FIGS. 1B and 1C are diagrammatic presentations of systems for controlling a production line of a processed food product, according to some embodiments of the invention;

FIG. 2 is a flowchart of a method of determining a quality of a processed food product, according to some embodiments of the invention;

FIGS. 3A-3C are NMR spectrums of a cooking oil, according to some embodiments of the invention; and

FIG. 4 is a flowchart of a method for controlling a production line of a processed food product, according to some embodiments of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PREFERRED EMBODIMENTS

In the following detailed description, numerous specific details are set forth in order to provide a thorough understanding of the invention. However, it will be understood by those skilled in the art that the present invention may be practiced without all of these specific details. In other instances, well-known methods, procedures, and components have not been described in detail so as not to obscure the present invention.

Embodiments of the invention may be related to a system (e.g., portable and/or hand-handled) for detecting the quality of processed food products using data obtained via magnetic measuring. Such a system may include a Magnetic Resonance Device (“MRD”), for example a Nuclear Magnetic Resonance (“NMR”) spectrometer, and a controller that may be configured to analyze the data obtained with the MRD e.g., NMR spectrums

Quality data of processed food products can be obtained via magnetic measurements taken with MRD's. Obtaining magnetic measurements that can be used to obtain the quality data of processed food products (e.g., have a sufficient signal to noise ratio), can require the MRD to transmit a magnetic field having a strength between 1 Tesla to 1.5 Tesla (or greater).

During magnetic measuring, the generated magnetic field is typically not only confined to an area where the processed food product to be measured is located, but typically extends from a magnetic energy source of the MRD (e.g., a permanent magnet) outward, decreasing in strength as the magnetic field extends further away from the magnetic energy source.

The portion of the magnetic field that extends beyond the location of the processed food product being measured (e.g., a magnetic fringe field) can be strong enough to harm its surrounding environment. For example, a magnetic field strength greater than 1 Tesla can cause a magnetic fringe field strength near the magnetic field source (e.g., within a 5 foot radius) that causes a pace maker inside of a human to break. Other matter that can be harmed by magnetic field exposure can include electronic equipment, cellular signals, and the like.

Magnetic fringe fields can be difficult to contain. For example, for magnetic measurements requiring a large magnetic field (e.g., above 1 Tesla), an MRD can be housed in a room where walls of the room are made of a material that behaves as a magnetic shield to shield an environment outside of the room from the magnetic fringe fields. An operator typically physically prepares to be inside the room to perform a measurement (e.g., rids themselves of any metal objects). A sample is transported into the room and placed within the MRD for measurement.

For example, one way to obtain an NMR spectrum of processed food products can require obtaining a sample of the processed food product (e.g., from a production line), transporting it to a room where an NMR spectrometer is set up with walls of a room that provide magnetic shielding, and obtaining the NMR spectrum with the NMR spectrometer. In this example, if the processed food product sample is taken from a food production line that is in process (e.g., a commercial food production line for making ketchup), by the time the NMR spectrum is analyzed (e.g., sample removed from the line and transported to the room for measurements), a half an hour or more can pass before the processed food product sample is imaged. If it is detected that the quality of the processed food product is below a desired food quality, all of the processed food product production between the time the sample was taken and the time the NMR spectrum is analyzed is lost. In addition, during manufacturing, it can be costly to have employees (typically scientists) to periodically (e.g., once per hour) perform the NMR measurements.

In some embodiments, taking NMR measurements of a food product in a laboratory environment is desirable, for example, in a food production line where other measurements need to be made in the laboratory. In yet another example, a food inspector may take samples of used cooking oils from various restaurants to a central laboratory to measure the quality of the used cooking oil. In these embodiments, using NMR device that has a magnetic fringe field can also slow down production, by for example, taking preparations that are necessary to conduct an NMR measurement where room walls are the magnetic shield.

In some embodiments of the invention, the system is constructed such that the MRD emits no magnetic fringe field (or substantially no magnetic fringe field) into the close environment. For example, the system may be constructed such that the magnetic field strength that extends into a close environment surrounding the system (e.g., less than a 5 foot radius surrounding the system) is below a value that can be harmful to humans, the environment, electronic components or the like,

Systems according to some embodiments of the invention obey magnetic fringe field safety regulations set by a regulatory body, for example, the magnetic fringe field of an NMR spectrometer may have a magnetic fringe field of less than 5 Gauss required by the FDA for magnetic measurement devices

Some embodiments may be related to a system and a method of measuring quality of food production and/or controlling a processed food production line using NMR spectrometry. In some embodiments, the system can be positioned on or very close to the processed food production line. In some embodiments, the system can be positioned in a laboratory near other laboratory equipment. The system can be positioned on or very close to the processed food production line, or in a laboratory, due to, for example, the substantially negligible magnetic fringe field. In this manner, the system can obtain magnetic measurements in real-time, analyze the magnetic measurements in real-time and provide feedback, for example, to the processed food production line in real time.

The NMR spectrometry can allow measurements of processed food product that may be sensitive to an amount and/or type of chemical bonds in the molecules constructing the food product. For example, when measuring oils, an NMR frequency response of a C—C single bond of the oil differs significantly from that of the NMR frequency response of a C═C double bond of the oil, such that NMR measurements can be used to distinguish between highly-saturated oils and lower-saturated hydrogenated oils.

The NMR spectrometry system can take measurements that can be non-destructive to the food product due to, for example, the negligible effect of the magnetic field necessary for the measurement can have on a chemical state of the food being processed. The NMR spectrometry system can provide a highly accurate measurement of quality of the food being processed while simultaneously avoiding destruction of the food product and/or magnetic field strengths that are harmful to the environment.

An online (e.g., measurement tool on or near a food production line or a laboratory), real-time measurement capable of being used for quality control may be conducted without (or substantially without) an interference of the processed food product production line and may allow evaluation of the quality of the processed food products produced in real time. The determined quality may be used to control at least some of the production line parameters. For example, if the determined quality indicates that the amount of sugar in the processed food product (e.g., ketchup) is above a predetermined level, the amount added may be reduced. If the detected quality is below a predetermined level (e.g., poor quality level) the production may be stopped and/or adjusted (e.g., temperature, flow speed, etc.

Quality detection according to embodiments of the invention may include analyzing NMR spectrums of the food product and/or the production line. The analysis may include identifying one or more peaks (maximum) in the measured NMR spectrums and correlating one or more identified peaks to a first component. If the first component is an undesired component, then a determination that the processed food product is of poor quality (e.g., having a forbidden component) can be made. If there is a determination that the processed food product is of poor quality, then one or more of the following actions can be taken: a) stop the production of the processed food product, b) stop using the processed food product (e.g., stop using a frying oil in a restaurant after several heating cycles), c) stop selling the processed food product, d) adjust the processed food product production line parameters, or e) dispose of processed food produced during a time period before the bad quality detection. In some embodiments, if the first component is a desired component the relative amount of the desired component may be estimated from analyzing the spectrum, for example, the amount of alcohol in Vodka may be detected to ensure that the Vodka was not diluted with water.

NMR spectrums may provide a detailed analysis on a biomolecular composition of a sample very quickly with relatively little to no sample preparation. NMR spectrometry can be a universal detector for all molecules containing NMR-active nuclei. For all proton-bearing molecules, the intensity of all proton signals can be absolutely proportional to a molar concentration of a metabolite of the molecule

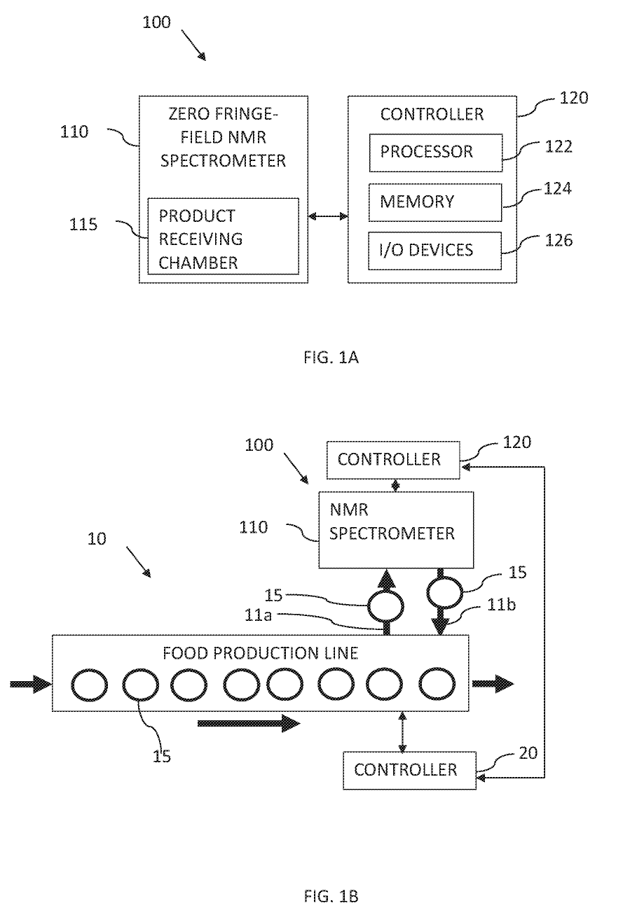

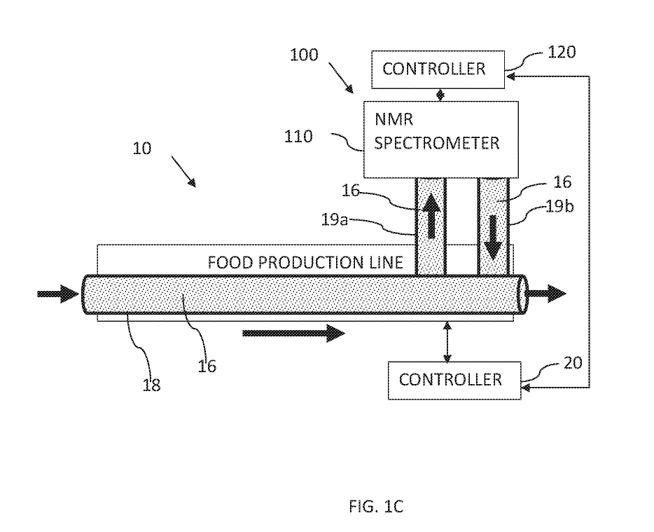

Reference is made to FIG. 1A, which is an illustrations of a system 100 for determining a quality of processed food product according to some embodiments of the invention.

System 100 can include a NMR spectrometer 110, a product receiving chamber 115, and a controller 120. The controller 120 can include a processor 122, memory 124, and an I/O device 126.

The product receiving chamber 115 can be in fluid communication with a process food production line (not shown). In some embodiments, the product receiving chamber 115 receives food being processed from the food production process line and outputs the food back into the food production process line. In some embodiments, the product receiving chamber 115 receives food being processed form the food production process line and outputs the food into a release outlet (not shown).

In some embodiments, product receiving chamber 115 can receive a processed food product or a sample of the processed food product. For example, when system 100 is placed in the laboratory or a warehouse, a discrete sample of the food product may be taken to system 100 in the laboratory (or elsewhere) and placed in product receiving chamber 115. The sample may include the whole food product (e.g., a bottle of wine) or a portion of the food product (e.g., a 100 ml of used cooking oil).

The NRM spectrometer 110 may positioned such that it can transmit and/or receive electromagnetic waves to/from the product receiving chamber 115. The NRM spectrometer 110 can be in communication with the controller 120. The controller 120 can be in communication with the food production line.

A system 100 may be portable or stationary. System 100 may be a stationary system located in a food production facility, for example, on the production line or in a laboratory of the food production facility. A portable system 100 may be carried (hand-handled) by the user to be used in various places. For example, system 100 may be carried by an inspector testing quality of food products at various warehouses/restaurants. System 100 may be safe to be hand-handled by a human user according to the required regulations. The NMR spectrometer 110 may be a zero-fringe field NMR spectrometer. The fringe magnetic field formed by the magnets of NMR spectrometer 110 may be lower than any hazarded or harmful field level, as may be set by a regulatory body such as the FDA or the NIST. NMR spectrometer 110 may include a housing that includes shielding and detecting equipment (e.g., antennas) for monitoring and shielding the environment from leakage of the fringe magnetic field and/or other electromagnetic radiation (e.g., radio-frequency (RF) radiation). Such leakages may come from magnets and/or RF antennas of NMR spectrometer 110. In some embodiments, the NMR spectrometer 110 may be 1H, 13C, 31P-NMR, 2D-NMR spectrometer and the like.

In some embodiments, NMR spectrometer 110 may include a product receiving chamber 115 for receiving the food product. The food product may be packed in a package (e.g., a bottle) or may be introduced to product receiving chamber in an unpacked from, for example, using tubes extracted from the main production line, as will be discussed below with respect to FIGS. 1B and 1C.

Controller 120 may include a processor 122, a memory 124 and an input/output (I/O) device 126. Processor 122 may be any processing unit such as a central processing unit (CPU), a chip or any suitable computing or computational device. Processor 122 may be configured to carry out methods according to embodiments of the present invention by for example executing instructions stored in a memory such as memory 124. Memory 124 may be or may include, for example, a Random Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory 124 may be or may include a plurality of, possibly different memory units.

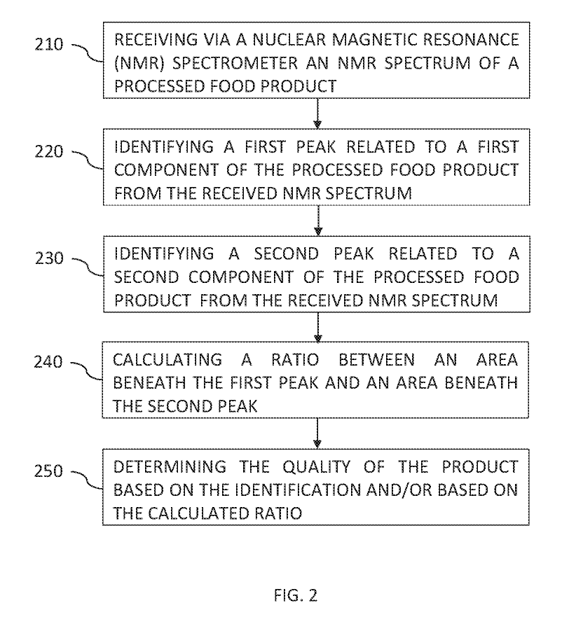

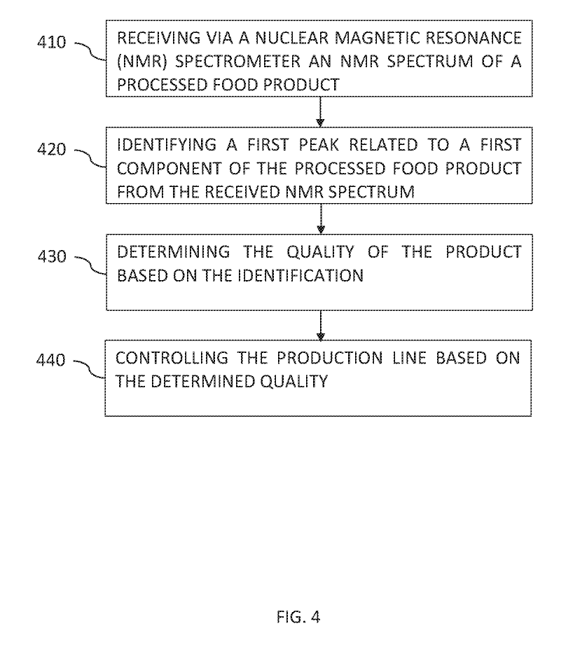

Memory 124 may store thereon instructions and codes to carry out methods according to embodiments of the present invention for example, a method of determining a quality of a processed food product (discussed with respect to the flowchart of FIG. 2) and/or methods of controlling a production line (discussed with respect to the flowchart of FIG. 4). Memory 124 may further store an operation system to perform tasks involving coordination, scheduling, arbitration, supervising, controlling or otherwise managing operation of controller 120.

I/O device 126 may include any applicable input/output (I/O) devices such as a screen, a touchscreen, a mouse, a keyboard, audio devices, a wired or wireless network interface card (NIC), a modem, printer or facsimile machine, a universal serial bus (USB) device or external hard drive and the like. I/O device 126 may be used for receiving instructions from a user and/or displaying results (e.g., of the quality determination) for the user.

Reference is made to FIG. 1B which is an illustration of a system for controlling a production line of a processed food product according to some embodiments of the invention. A system 100 may include a Nuclear Magnetic Resonance (NMR) spectrometer 110, located on a production line 10 and a controller 120. NMR spectrometer 110 and controller 120 may include the same components as NMR spectrometer 110 and controller 120 of FIG. 1A, as described above. One or more NMR spectrometers 110 may be placed along one or more location in production line 10 that may require a quality control of a processed food product 15. Processed food product 15 may be any discrete food product 15 either a packed item in package (e.g., oil or juice in a bottle) or an unpacked item (e.g., pastry, chocolate bars, etc.).

A product receiving chamber (e.g., chamber 115) of NMR spectrometer 110 may be configured to continually receive processed food products 15 to be tested by NMR spectrometer 110. In some embodiments, at least some of proceed food products 15 from production line 10 are temporarily shifted aside from production line 10 to inlet test line 11a. Production line 10 may include a plurality of conveyors (or other conveying means) for conveying processed food products 15 along all portions of production line 10. Inlet test line 11a may lead processed food product 15 to product receiving chamber 115 and an outlet line 11b may lead processed food product 15 back to production line 10.

The NMR spectrometry testing may be held when processed food product 15 is inside NMR spectrometer 110, either when processed food product 15 is stationary (stop for a moment for conducting the test) or while processed food product 15 is traveling (e.g., on a conveyor) inside NMR spectrometer 110. In some embodiments, a speed at which the NMR spectrometry testing is conducted is synchronized or correlated to a speed at which products 15 are conveying in production line 10 (e.g., the production speed). In various embodiments, conducting the NMR spectrometry testing on at least some of products 15 does not slow down or cause a delay in the production speed.

Reference is made to FIG. 1C which is an illustration of a system for controlling a production line of a processed food product according to some embodiments of the invention. System 100 may include an NMR spectrometer 110, located on a production line 10 and a controller 120. NMR spectrometer 110 and controller 120 may include the same components as NMR spectrometer 110 and controller 120 of FIG. 1A, as described above.

Production line 10 of FIG. 1C may include a closed tube or an open conduit 18 for continuously conveying a processed food product 16 in a liquid or powder form. Processed food product 16 may include, for example, =juices, oils, sugar, flower, etc. One or more NMR spectrometers 110 may be placed along one or more location in production line 10 that may require a quality control of processed food product 16.

In some embodiments, at least a portion of processed food product 16 is extracted to be consciously tested by NMR spectrometer 110. The portion of food product 16 to be tested may continuously flow in and out of product receiving chamber 115 via inlet tube (or conduit) 19a and outlet tube (or conduit) 19b. Inlet 19a may deliver processed food product 16 from tube 18 to product receiving chamber 115 and outlet 19b may deliver processed food product 16 from product receiving chamber 115 back to tube 18. The NMR spectrometry testing may be conducted while processed food product 16 is traveling (e.g., flowing) in NMR spectrometer 110.

In some embodiments, both production lines 10 of FIGS. 2A and 2B are controlled by a controller 20. Controller 20 may be configured to receive inputs regarding the quality of processed food products 15 or 16 from controller 120 and may control various production parameters based on that quality. The production parameters may include: initiation or stopping of production line 10, production speed, conveying/delivery speed, temperatures at various production stages, an amount of different ingredients to be added to processed food products 15 or 16, pressures, and the like.

Controller 20 may control at least some of the components included in production line 10, for example, the conveyors, mixers, pumps, heaters, ovens, dryers or any other equipment included in production line 10. In some embodiments, controller 120 and controller 20 are the same controller, controlling both production line 10 and system 100.

I some embodiments, the NMR spectrometry test conducted by systems 100 of FIGS. 1A-1C is a non-invasive or non-destructive test. Therefore, a processed food product that may enter system 100 may not undergo any chemical/physical changes and therefore can be shift or delivered back to the production line or to any other location (e.g., storage) unharmed.

In some embodiments, all the NMR spectrometry testing conducted by systems 100 of FIGS. 1A-1C are conducted in real-time. In some embodiments, the feedback received from the NMR spectrometry testing (e.g., the quality determination) is used in real-time to either control the production line or to make a decision regarding stoke of processed food products.

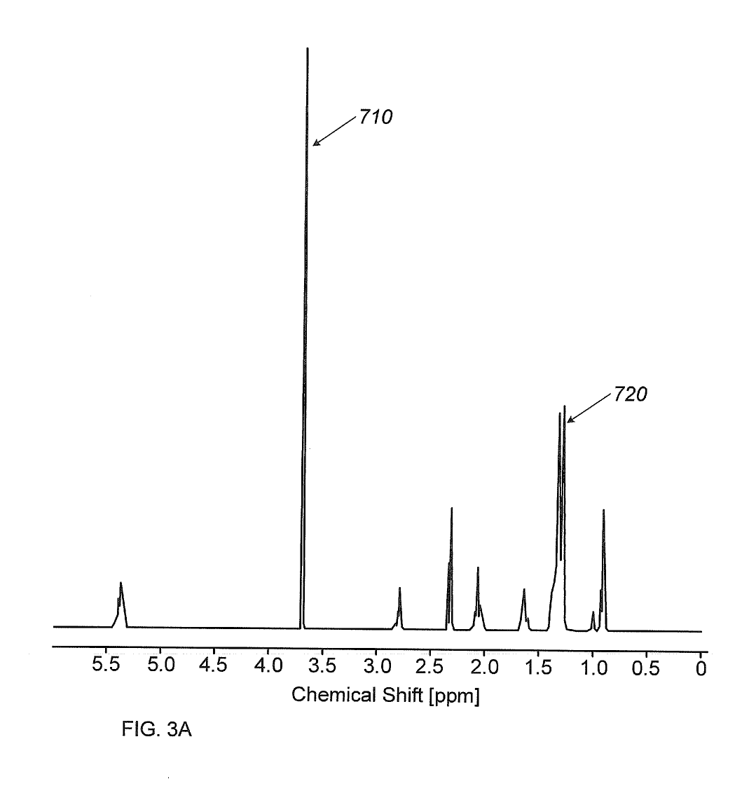

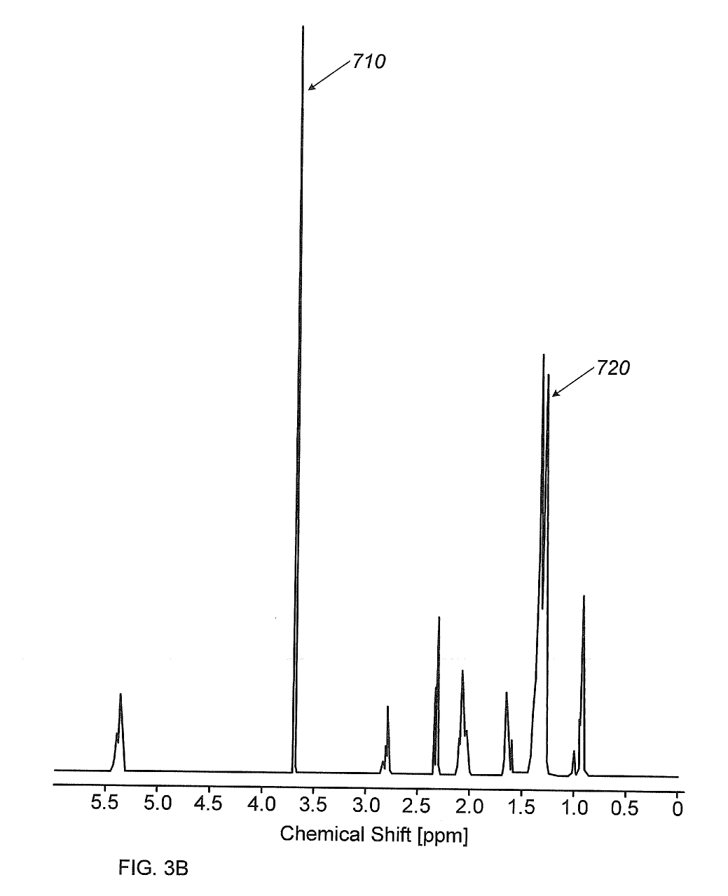

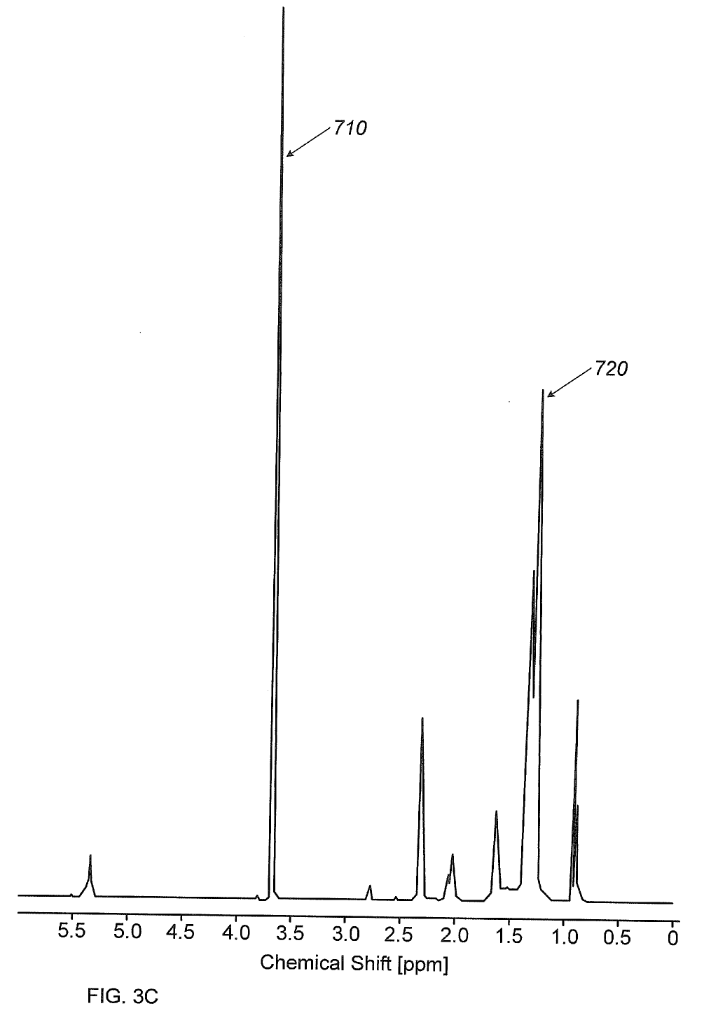

Reference is made to FIG. 2 which is a flowchart of a method of detecting a quality of a processed food product according to some embodiments of the invention. The method of FIG. 2 may be executed by processor 122 of controller 120 (or the processor of controller 20) based on codes and instructions stored in memory 124, or may be executed by any other suitable controller. The method can involve receiving via an NMR spectrometer (e.g., spectrometer 110) an NMR spectrum of the processed food product (Step 210). The processed food product may include cooking oils, such as olive oils, fruit juices, a medicinal plant, an ingredient for Chinese medicine, an ingredient for other natural medicine, a plant extract, an herb, a spice, coffee, tea, sugar, flour, rubber, commercially produced foodstuffs and any combinations thereof. Some examples of NMR spectrums received from an NMR spectrometer are shown in FIGS. 3A-3C.

Turning to FIG. 3A-3C, the NMR spectrums of FIGS. 3A-3C are exemplary NMR spectrums of a food product during three processing stages. The NMR spectrum of FIG. 3A was received from a preprocessed food product. The spectrum of FIG. 3B was received from the food product after a first processing stage. The spectrum of FIG. 3C was received from the food product after a second processing stage. In some embodiments, the food product may be oil, fruit juice, wine, or the like. The NMR spectrums of FIGS. 3A-3C are represented as intensity vs. the normalized frequency. The raw data received from an NMR spectrometer can include the intensity vs. the frequency. For different NMR spectrometers that work at different frequency bends (e.g., 1H, 13C, 31P-NMR, 2D-NMR) in order to, for example, compare the received data, the frequency may be normalized to the entire frequency bend of the specific NMR spectrometer used to take the measurement and represented as chemical shift [ppm].

Turning back to FIG. 2, the method can involve identifying a first peak related to a first component of the processed food product from the received NMR spectrum (Step 220). As shown in FIGS. 3A-3C the NMR spectrums include a plurality of peaks. These peaks may be identified to be related to components in the processed food product. For example, controller 120 may identify peak 710 of FIGS. 3A-3C as related to water. A data that correlates peaks to components (e.g., a lookup table) may be stored in a database associated with controller 120 (e.g., memory 124 or elsewhere).

Heating of cooking oil may cause degradation and hydrogenation over time. Both the degradation and the hydrogenation may cause carcinogenic degradation products and carcinogenic free radicals, typically associated with the double bonds resulting from hydrogenation. Therefore, reuse of oils, especially extended reuse, can become a health hazard for cooks.

An example for a common cooking oil is olive oil. Olive oil includes mainly triglycerides (more than 98%) and other minor components (about 1-2%) such as squalene, α-tocopherol, phytosterols, phenolic compounds, carotenoids, and aliphatic and terpenic alcohols, which constitute the unsaponifiable fraction of the oil. Other common cooking oils include: peanut oil, walnut oil, canola oil, almond oil, avocado oil, butter, coconut oil, corn oil, cottonseed oil, flax seed oil, ghee, grapeseed oil, hazelnut oil, hemp oil, lard, macadamia oil, margarine, mustard oil, olive pomace oil, palm oil, pumpkin seed oil, rice bran oil, safflower oil, sesame oil, soybean oil, sunflower oil, beef tallow, tea seed oil, vegetable shortening, or any combination thereof.

In some embodiments, the first component is undesired component for example; the existence of water in cooking oil is undesired. In some embodiments, the first identified peak is related to other undesired components in cooking oil such as free fatty acids, hydroperoxides, polymerized triglycerides, aflatoxin and Polycyclic Aromatic Hydrocarbons (PAHs) and the like.

In some embodiments, the method involves calculating a normalize area beneath the identified peak. The normalize area beneath each peak may be proportional to the amount of the related component in the processed food product. In some embodiments, the entire area beneath each peak in the spectrum is calculated. In some embodiments, each calculated area is divided by the total area beneath all the peaks in the NMR spectrum, to receive the normalize area. The outcome of this calculation may derive the relative amounts of each component in the processed food product.

The method may involve identifying a second peak related to a second component of the processed food product from the received NMR spectrum (Step 230). For example, controller 120 may identify peak 720 as related to a second component in the food product. In some embodiments, the second component may also be an undesired component.

In some embodiments, both the first component related to the first peak and the second component related to the second peak may be desired components. For example, if the processed food product is a fruit juice, the first peak may be related to a first type of sugar (e.g., sucrose) and the second peak to a second type of sugar (e.g., fructose). In some embodiments, in order to determine the quality of the fruit juice it is required to calculate the relative amounts of the sucrose and fructose. In another example, if the processed food product is an alcoholic beverage, the first component may be water and the second component may be alcohol. In yet another example, the processed food product may be cooking oil and the first component may be a first type of fat acid and the second component may be a second type of fat acid.

The method can involve calculating a ratio between an area beneath the first peak and an area beneath the second peak (Step 240). The ratio between the calculated areas may be related to the relative amounts of the first and second components in the processed food product.

The method can involve determining the quality of the processed food product (Step 250). The quality may be determined based on the identification of the first peak. For example, if an undesired component was related to the identified first peak, controller 110 may be configured to determine that the processed food product is of poor quality. In some embodiments, the calculated normalized area beneath the first peak is proportional to the amount of the undesired first component and controller 110 may be configured to determine that the processed food product is of poor quality if the normalized area is above a predetermined threshold value. In some embodiments, even when the first component is a desired component, having higher or lower levels (out of the allowed range) of the amount of the desired component can harm the quality of the processed food product. A data related to a desired (or undesired) ranges of the amount of components in the processed food product (e.g., a lookup table) may be stored in a database associated with controller 120 (e.g., memory 124) or elsewhere.

In some embodiments, the quality of the processed food product is determined based on the ratio between the calculated areas beneath the first and second peaks. The ratio between the calculated areas may be substantially the same as the ratio between the amounts of the first and second components. For example, in fruit juice the ratio between the calculated first and second peaks may be related to the amounts of sucrose and fructose. The calculated ratio may indicate if sugars, such as sucrose, were artificially added to the fruit juice. In another example, calculating the ratio between alcohol and water in Vodka may indicate if the Vodka was diluted with water. In yet another example, calculating the ratio between specific fat acids may indicate if the olive oil is a virgin olive oil, an olive oil diluted with soy oil, etc.

I some embodiments, a data comprising a lookup table of identified peaks and the related components may be stored in a database associated with controller 120 (or 20), for example, in memory 124. In some embodiments, the data is stored elsewhere and may be received by controller 120 via a communication unit (e.g., over the internet). The data may further include a lookup table of the relative amounts of one or more components (either desired or undesired components) in the processed food product.

In some embodiments, the method can further involve additional analysis of the received spectrum. One of the problems in NMR spectrum (e.g., 1H-NMR spectrum) can be the large water peak (e.g., peak 710), caused by residual water which can overlap with the anomeric protons of sugars or glycosides (δ=4.8-5.2). To suppress this undesired water peak, several methods may be applied, e.g., addition of paramagnetic ions like Mg2+ followed by Meiboom-Gill modification of the Can-Purcell (CPMG) spin-echo pulse program and pre-saturation using an additional pulse. To avoid unwanted suppression, the temperature and pH of samples may be selected to minimize the water signal, since they strongly affect it.

Depending on the molecular size of the metabolites (e.g., compounds or components), specific pulse sequences may be applied, to separate signals from small molecules from those of large ones, for example, by spin diffusion differences.

In the case of a matrix containing macromolecules (e.g., proteins or lipid vesicles) the application of a spin-echo sequence like the CPMG pulse sequence may allow the attenuation of unwanted resonances from the macromolecules.

Reference is made to FIG. 4 which is a flowchart of a method of controlling a production line of a processed food product according to some embodiments of the invention. The method of FIG. 2 may be executed by processor 122 of controller 120 (or the processor of controller 20) based on code sand instructions stored in memory 124 (or a memory associated with controller 20), or may be executed by any other suitable controller. Steps 410-430 may be substantially the same as Steps 210, 220 and 250 of the flowchart of FIG. 2. In some embodiments, the method of FIG. 4 further includes any one of the steps disclosed above with respect to FIG. 2 (e.g., Steps 210-250). In some embodiments, controller 120 or 20 is configured to receive an NMR spectrum from NMR spectrometer 110 and determine the quality of processed food products 15 or 16 according to any one of the methods and steps disclosed above.

The method of FIG. 4 can involve controlling the production line based on the determined quality. If the determined quality yields that food product 15 or 16 is of a poor quality controller 120 and/or 20 may change the production parameters of production line 10 based on the determined quality. A quality determined as “poor quality” may include at least one of the following reasons: an un desired component detected in the processed food product, an amount of the undesired component is above a predetermined threshold value, an mount of a desired component is out of the allowed range, relative amounts of two desired components are out of the allowed range and the like. In some embodiments, based on the detected quality controller 20 (and/or 120) can stop the production, change amounts of ingratiates that may be added to food product 15 or 16, change the temperature or pressure at various stages (e.g., a preparation tank, cooking ovens, dries) in the production line, etc.

In some embodiments, the method of FIG. 4 includes a continuous or periodic quality control (quality determination) of processed food product 15 or 16 during the production process according to any of the embodiments of the invention, and adjusting the production parameters (if necessary) based on the determined quality.

### EXAMPLES

### Example 1—Ilex

Eleven species of Ilex were analyzed. NMR spectrum was received from each of the Ilex species. Peaks related to arbutin, phenylpropanoids and caffeine were identified and, based on these peaks, the different Ilex species were distinguished. For example, caffeine and theobromine peaks were only found in the I. paraguariensis, whereas arbutin peak was found only in the other species.

### Example 2—Strychnos

Three different Strychnos species were characterized using different parts of the plants (seeds, roots, leaves and bark). All samples were clearly distinguishable based on their components (e.g., identified peaks) such as brucine, loganin, Strychnos icaja alkaloids (icajine, sungucine) as well as fatty acids.

### Example 3—Cannabis Sativa

Twelve Cannabis sativa cultivars were identified based on the relative amounts of the following compounds: THCA, CBDA, glucose, asparagine and glutamic acid. The relative amounts were calculated according to embodiments of the invention.

### Example 4—Chinese Medicines

Traditional Chinese medicines (TCM) are often a mixture of several plants, and the fractions of the various plants in the medicine as sold can be quite variable, as the quality control regulations tend to focus on the presence and quantity of a certain compound or group of compounds, rather than the total composition of the medicine.

### Ephedra

Three different species of Ephedra, E. sinica, E. intermedia, and E. equisetina, are commonly and interchangeably used in Chinese medicine. Typically, regulations specify the amount of ephedrine alkaloids (0.8% of dry weight).

Methods of the invention were used to distinguish between E. sinica, E. intermedia and E. distachya. Distinguishing characteristics included the amounts of and types of both ephedrine alkaloids, and the secondary component, benzoic acid analogue. For example, from nine tested of commercial Ephedra materials, one was shown to be a mixture of two species; the others included a single species.

### Ginseng

Ginseng (Panax ginseng) preparations are among the most popular herbal medicines. Ginseng products can be made from ginseng of different ages (4, 5 and 6 years old) and from different processing methods (white and red). Various ginseng products can be distinguished by detecting according to fractions of compounds such as, but not limited to, alanine, arginine, fumaric acid, inositol and ginsenosides. The related peaks of each fraction were identified using system and methods of the invention.

### Example 5—Adulteration of Fruit Juices

The quality of fruit juice may be related to a concentration of a particular compound or deviations in the concentration the specific compound, in comparison with reference standards. This can indicate characteristic quality and authenticity problems. For example, an addition of sugar (e.g., sucrose) to fresh orange juice. In some embodiments, absolute concentrations of compounds (components) in a fruit juice can be found, as disclosed above with respect to the flowchart of FIG. 2. A system like system 100 may identify peaks related to, but are not limited to, sucrose, glucose, fructose, proline, alanine, 5-hydroxymethylfurfural (HMF), ethanol, methanol, acetone, phlorin, acetaldehyde, benzaldehyde, acetoine, arbutine, malic acid, citric acid, isocitric acid, chlorogenic acid, lactic acid, fumaric acid, quinic acid, succinic acid, citramalic acid, formic acid, benzoic acid, acetic acid, sorbic acid, gluconic acid and galacturonic acid. Furthermore, relationships between various components can be calculated according to some embodiments of the invention, such as the ratio of glucose to fructose or the ratio of sucrose to total sugars.

The system (e.g., controller 120) may calculate the relative amount of each identified component. Therefore, frauds can be detected, such as, but not limited to, the addition of sugar to a juice, exhaustive enzymatic treatment (detected by the presence of: galacturonic acid), addition of citric acid or lemon juice (e.g., in apple juice), extraction of orange peel (detected by the presence of: phlorin) or the usage of unripe fruits (e.g., high concentration of quinic acid in apple juice),

### Example 6—Estimation of the Fruit Content of a Fruit Juice

Conventionally, the fruit content of a juice may be estimated by quantifying selected compounds and minerals and comparing these amounts with reference data. A system, such as, system 100, may measure a plurality of variables components and their relative amount) on the basis of just one NMR spectrum so that regression analysis may be used to estimate the fruit content. Tests have shown that, for more than 95% of the samples, the quantifying results have a relative accuracy of about 10%.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. A portable system for determining the quality of processed food product, comprising:
a Nuclear Magnetic Resonance (NMR) spectrometer; and
a controller configured to:
receive an NMR spectrum of the processed food product from the NMR spectrometer;
identify a first peak related to a first component of the processed food product from the received NMR spectrum; and
determine the quality of the processed food product based on the identification.

2. The portable system of claim 1, wherein the first component is an undesired component.

3. The portable system of claim 1, wherein the controller is further configured to:
calculate a normalized area beneath the first peak; and
determine the quality of the processed food product further based on the calculated normalized area.

4. The portable system of claim 2, wherein the processed food product is cooking oil and the undesired component is at least one of: free fatty acids, hydroperoxides, polymerized triglycerides, aflatoxin and Polycyclic Aromatic Hydrocarbons (PAHs).

5. The portable system of claim 1, wherein the controller is further configured to:
identify a second peak related to a second component of the processed food product from the received NMR spectrum;
calculate a ratio between an area beneath the first peak and an area beneath the second peak; and
determine the quality of the processed food product further based on the calculated ratio.

6. The portable system of claim 5, wherein the processed food product is an alcoholic beverage and the first component is water and the second component is alcohol.

7. The portable system of claim 5, wherein the processed food product is a fruit juice and the first component is a first type of sugar and the second component is a second type of sugar.

8. The portable system of claim 5, wherein the processed food product is cooking oil and the first component is a first type of fat acid and the second component is a second type of fat acid.

9. The portable system of claim 1, wherein the portable system is a hand-held system.

10. The portable system of claim 1, wherein the portable system is safe to be handled by a human user.

11. (canceled)

12. (canceled)

13. (canceled)

14. (canceled)

15. (canceled)

16. (canceled)

17. A method of detecting a quality of a processed food product, comprising:
receiving via a Nuclear Magnetic Resonance (NMR) spectrometer an NMR spectrum of the processed food product;
identifying a first peak related to a first component of the processed food product from the received NMR spectrum; and
determining the quality of the processed food product based on the identification.

18. The method system of claim 17, wherein the first component is an undesired component.

19. The method system of claim 17, further comprising:
calculating a normalized area beneath the first peak; and
determining the quality of the processed food product further based on the calculated normalized area.

20. The method system of claim 17, wherein the processed food product is cooking oil and the undesired component is at least one of: free fatty acids, hydroperoxides, polymerized triglycerides, aflatoxin and Polycyclic Aromatic Hydrocarbons (PAHs).

21. The method system of claim 17, further comprising:
identifying a second peak related to a second component of the processed food product from the received NMR spectrum;
calculating a ratio between an area beneath the first peak and an area beneath the second peak; and
determining the quality of the product further based on the calculated ratio.

22. The method system of claim 21, wherein the processed food product is an alcoholic beverage and the first component is water and the second component is alcohol.

23. The method system of claim 21, wherein the processed food product is a fruit juice and the first component is a first type of sugar and the second component is a second type of sugar.

24. The method system of claim 21, wherein the processed food product is cooking oil and the first component is a first type of fat acid and the second component is a second type of fat acid.

25. (canceled)

26. (canceled)

27. (canceled)

28. (canceled)

29. (canceled)

30. (canceled)
